(19) United States
(12) Patent Application Publication
(10) Pub. No.: US 2002/0159204 A1
(43) Pub. Date: Oct. 31, 2002

(54) Magnetic heads using a tunneling magnetoresistance effect

(75) Inventor: Yasuhiko Shinjo, Atsugi-shi (JP)

Correspondence Address: DARBY & DARBY P.C., POST OFFICE BOX 5257, NEW YORK, NY, 10150-5257, US

(73) Assignee: MITSUMI ELECTRIC CO., LTD.

(21) Appl. No.: 10/128,978

(22) Filed: Apr. 24, 2002

(30) Foreign Application Priority Data
Apr. 27, 2001 (JP) 2001-130648

(51) Int. Cl. G11B 5/39

(52) U.S. Cl. 360/324.2

(57) ABSTRACT

A magnetic head having a tunneling magnetoresistance effect achieves high density recording by narrowing a writing track width of a recording head. The magnetic head has a tunneling magnetoresistance effect and includes a first non-magnetic layer disposed on a substrate. A regenerating magnetic head, anchored in the first non-magnetic head, includes a regenerating magnetic core. A regenerating magnetic gap of the regenerating magnetic head is directed toward a side face direction of the first non-magnetic layer. A tunneling magnetoresistance effect element is connected to the magnetic core. A magnetic flux from the tunneling magnetoreisistance effect element is applied to the tunneling magnetoresistance effect element. A second non-magnetic layer is disposed on the tunneling magnetoresistance effect element. A shield magnetic layer is disposed on the second non-magnetic layer. A third non-magnetic layer is disposed on the shield magnetic layer. A recording magnetic head is disposed on the third non-magnetic layer. A recording magnetic gap of the recording magnetic head being directed toward a side face direction. A magnetic field generating element supplies a magnetic flux to the recording magnetic core and generating a magnetic field in the recording magnetic gap.

### BACKGROUND OF THE INVENTION

1. Field of the Invention

The present invention relates to magnetic heads having tunneling magneto-resistance effect elements as magnetism-sensitive elements.

2. Description of the Related Art

It is known to prepare a thinly layered magnetic head using a thin layer forming method for forming a magnetism-sensitive element such as a magnetoresistance effect element. As shown in FIG. 6, a thinly layered magnetic head consists of a lower regenerating head section and an upper recording head section. The lower regenerating head section includes a magnetoresistance effect element 100 (hereinafter called “Mk element 100”) between a lower shield layer 102 and an upper shield layer 103. A lower insulation layer 101a is deposited atop lower shield layer 102. An upper insulation layer 101b is deposited below upper shield layer 103.

The upper recording head section includes a recording head 105 which is formed above MR element 100. Recording head 105 is, in multi-layered construction, composed of upper shield layer 103, a magnetic gap layer 106, an upper core layer 107. A coil 108 is disposed between magnetic gap layer 106 and upper core layer 107.

According to the thinly layered magnetic head under the foregoing structure, when an outer magnetic field exists, the resistance value of MR element 100 varies in response thereto. The resulting resistance variation in MR element 100 is detected as a varying voltage. Thus, the outer magnetic field is detected.

A magnetic flux flows into a magnetic core comprising upper shield layer 103 and upper core layer 107 due to the magnetic field generated by coil 108. As a result, leakage magnetic field is generated through magnetic gap layer 106. A signal magnetic field is written by recording head 105.

In such multi-layered recoding head 105, when it is desired to form a writing track width wo of less than 1.0 micrometer, it is very difficult to narrow the writing track width wo using conventional photo lithographic processes because of a high stage h (about 10 to 15 micrometers) of upper core layer 107 as shown in FIG. 7. Today it is urgently required to narrow the width of writing tracks in recording head 105. Accomplishing such narrowing is very difficult for a photo lithographic process to form such narrow track widths in the foregoing magnetic head in which a number of layers are laid one upon another. Consequently, such a conventional magnetic head is not available for a high-density recording.

### OBJECTS AND SUMMARY OF THE INVENTION

It is therefore an object of this invention to provide a magnetic head having a tunneling magnetoresistance effect which is capable of achieving high density recording by narrowing a track width of a recording head as well as of a regenerating head.

Briefly stated, the present invention provides a magnetic head having a tunneling magnetoresistance effect to achieve high density recording by narrowing a writing track width of a recording head. The magnetic head has a tunneling magnetoresistance effect and includes a first non-magnetic layer disposed on a substrate. A regenerating magnetic head, anchored in the first non-magnetic head, includes a regenerating magnetic core. A regenerating magnetic gap of the regenerating magnetic head is directed toward a side face direction of the first non-magnetic layer. A tunneling magnetoresistance effect element is connected to the magnetic core. A magnetic flux from the tunneling magnetoreisistance effect element is applied to the tunneling magnetoresistance effect element. A second non-magnetic layer is disposed on the tunneling magnetoresistance effect element. A shield magnetic layer is disposed on the second non-magnetic layer. A third non-magnetic layer is disposed on the shield magnetic layer. A recording magnetic head is disposed on the third non-magnetic layer. A recording magnetic gap of the recording magnetic head being directed toward a side face direction. A magnetic field generating element supplies a magnetic flux to the recording magnetic core and generating a magnetic field in the recording magnetic gap.

According to an embodiment of the invention, there is provided a magnetic head having a tunneling magnetoresistance effect comprising: a substrate, a first non-magnetic layer on the substrate, a regenerating magnetic head anchored in the first non-magnetic layer, the regenerating magnetic head including a regenerating magnetic core, a regenerating magnetic gap of the regenerating magnetic core being directed toward a side face direction of the first non-magnetic layer, a tunneling magnetoresistance effect element connected to the magnetic core, a magnetic flux from the tunneling magnetoreisistance effect element being applied to the tunneling magnetoresistance effect element, a second non-magnetic layer disposed on the tunneling magnetoresistance effect element, a shield magnetic layer disposed on the second non-magnetic layer, a third non-magnetic layer disposed on the shield magnetic layer, a recording magnetic head disposed on the third non-magnetic layer, a recording magnetic gap of the recording magnetic head being directed toward a side face direction, and magnetic field generating means for supplying a magnetic flux to the recording magnetic core and thereby generating a magnetic field in the recording magnetic gap.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective view of a main part of a magnetic head having a tunneling magnetoresistance effect according to the present invention.

FIG. 2 is a perspective view of a regenerating magnetic core in the magnetic head in FIG. 1.

FIG. 3 is a perspective view of a tunneling magnetoresistance effect element in the regenerating magnetic core in FIG. 2.

FIG. 4 is a schematic section view of the tunneling magnetoresistance effect element in FIG. 3.

FIG. 5 is a plan view of a coil in a recording magnetic head used in FIG. 1.

FIG. 6 is an exploded perspective view of a conventional magnetic head.

FIG. 7 is a schematic side view of the conventional recording head in FIG. 6

### DETAILED DESCRIPTION OF THE PREFERRED EMBODIMENTS

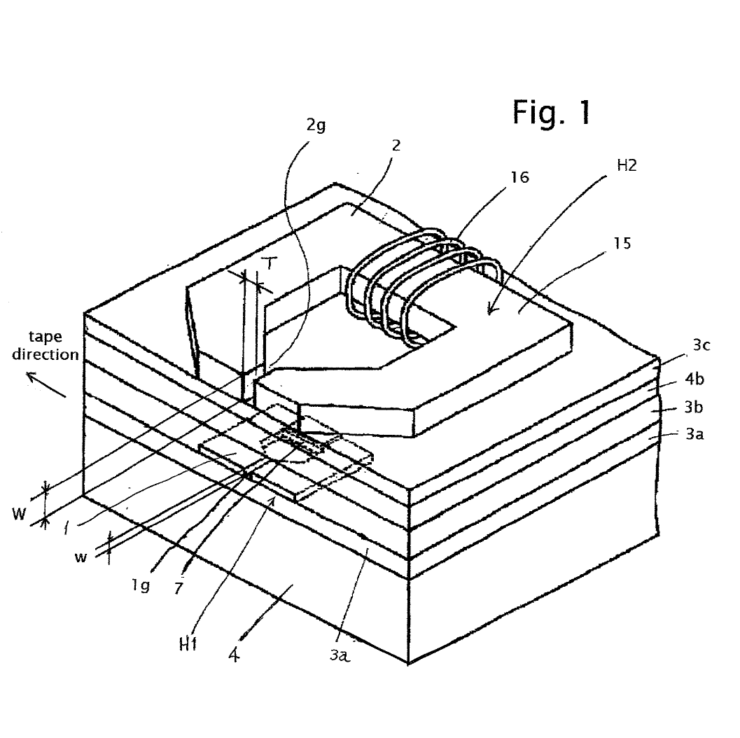

Referring now to FIG. 1, a magnetic head having a tunneling magnetoresistance effect comprises a regenerating magnetic head H1 and a magnetic recording head H2. A first non-magnetic layer 3a is disposed on a substrate 4 which is made of a ceramic material such as aluminium oxide titanum carbide(Al203-Ti—C) or the like. A second non-magnetic layer 3b is disposed on first non-magnetic layer 3 a for the purpose of electrical insulation.

Regenerating magnetic head Hi is anchored in first non-magnetic layer 3a. Regenerating magnetic head H1 includes a regenerating magnetic core 1. A tunneling magnetoresistance effect element 7 is connected to magnetic core 1. A regenerating magnetic gap I g in tunneling magnetoresistance effect element 7 is directed toward a side face of second non-magnetic layer 3b. A shield magnetic layer 4b is disposed on second non-magnetic layer 3b. A third non-magnetic layer 3c is disposed on shield magnetic layer 4b. Second and third non-magnetic layers 3b and 3c are made of A1203 or the like. Shield magnetic layer 4 is made of, for example, NiFe.

A recording magnetic head H2 is disposed on non-magnetic layer 3c. Recording magnetic head H2 includes a recording magnetic core 2, a coil 16 and a recording magnetic gap 2g. Recording magnetic gap 2g is directed toward a side face of non-magnetic layer 3c. A center axis of recording magnetic gap 2g is exactly aligned in a vertical direction with that of regenerating magnetic gap 2g.

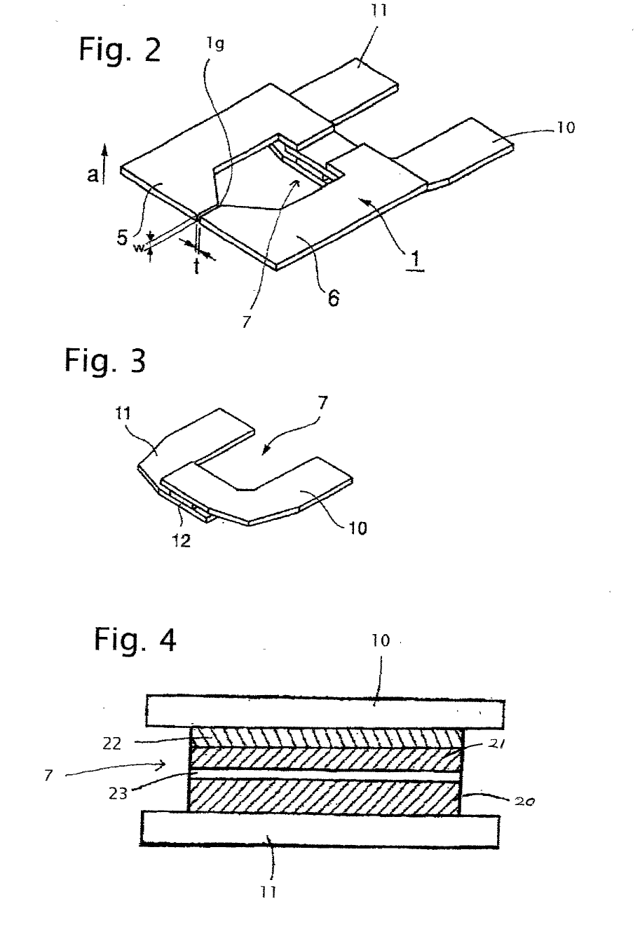

Referring now to FIG. 2, regenerating magnetic core 1 is composed of a pair of yokes 5, 6 opposing to each other to form regenerating magnetic gap 1g. Regenerating magnetic gap 1g has a length t and a track width w. Tunneling magnetoresistance effect element 7(hereinafter called “TMR element 7”) is formed on the opposite side of magnetic gap 1g.

Yokes 5, 6 are made of a magnetic material capable of drawing a signal magnetic field from a magnetic recording medium(not illustrated). Yokes 5, 6 can be formed so as to have a preferred shape and width by means of a thin layer forming process such as spattering, vacuum evaporation or the like as well as by a photo lithographic process including a resist patterning. Thus, magnetic gap 1g of regenerating magnetic core 1 is formed so that the thickness and spacing of yokes 5, 6 form a preferred track width w and gap length t. Accordingly, track width w and gap length t of magnetic gap 1g of regenerating magnetic core 1 is controllable by setting the thickness of magnetic core 1 using any of the foregoing processes.

Referring to FIG. 4, TMR element 7 includes a magnetism-free layer 20 for varying a magnetism direction toward a magnetic flux flowing in regenerating magnetic core 1. An insulating layer 23 is formed on magnetism-free layer 20. A magnetism fixing layer 21 is formed on insulating layer 23. Magnetism fixing layer 21 holds the direction of magnetism direction toward a magnetic flux flowing in regenerating magnetic core 1. A reinforced magnetism fixing layer 22 is formed atop magnetism fixing layer 21.

TMR element 7 further includes an upper electrode 10 and a lower electrode 11 which are connectable to a power source (not shown). Magnetism free layer 20, insulating layer 23, magnetism fixing layer 21 and reinforced magnetism fixing layer 22 are laid one upon another between upper electrode 10 and lower electrode 11.

When a certain voltage is applied to TMR element 7, it becomes available to provide a tunnel current between magnetism fixing layer 21 and magnetism free layer 20 by way of insulation layer 23. Since TMR element 7 is not able to detect a magnetic flux directly from the magnetic recording medium, it is not necessary to further narrow the track width of TMR element 7.

Returning to FIG. 1, recording magnetic core 2 includes a U-shaped yoke 15 and coil 6 for supplying a magnetic flux to U-shaped yoke 15. Magnetic gap 2g has a length T and a track width W. U-shaped yoke 15 is made of a magnetic material that permits magnetic flux to flow into U-shape yoke 15 in a preferred direction due to the magnetic field generated by certain electric current supply to coil 16. U-shaped yoke 15, just like a pair of yokes 5, 6, is formed in a preferred length and width by means of a thin membrane forming procedure such as spattering, vacuum evaporation or the like as well as a photo lithographic procedure including a resist patterning. Accordingly, U-shaped yoke 15 can be prepared in a manner which yields a preferred track width W. The track width T of U-shaped yoke 15 is controllable in the same way by setting the track width of magnetic recording core 2 using any of the foregoing processes.

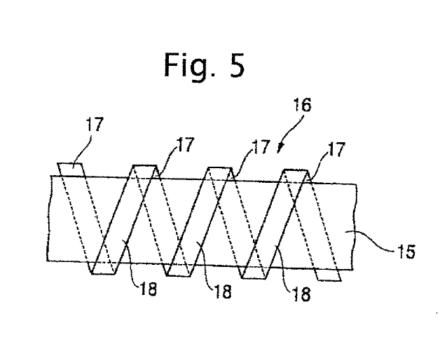

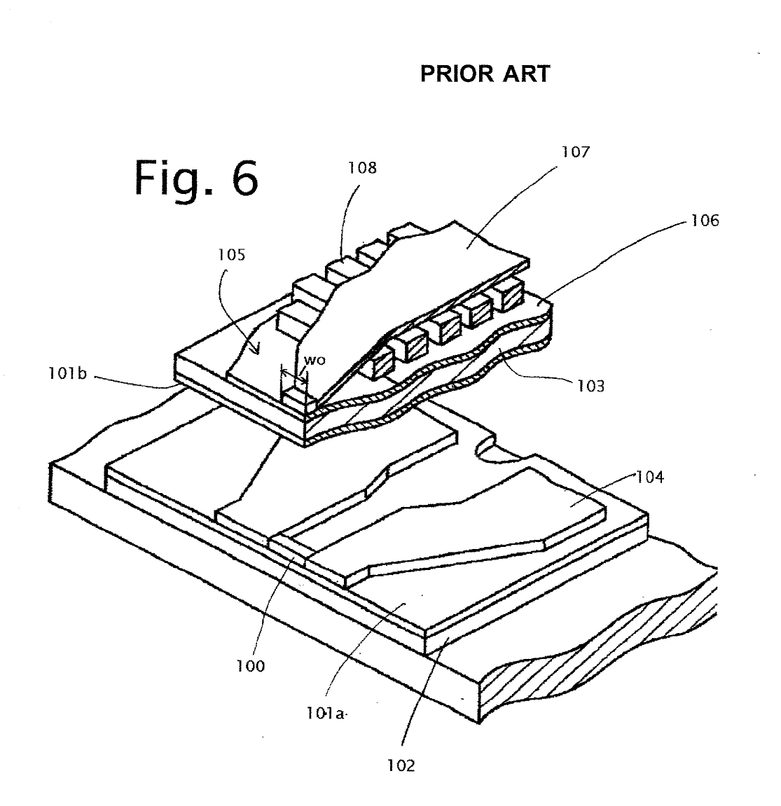

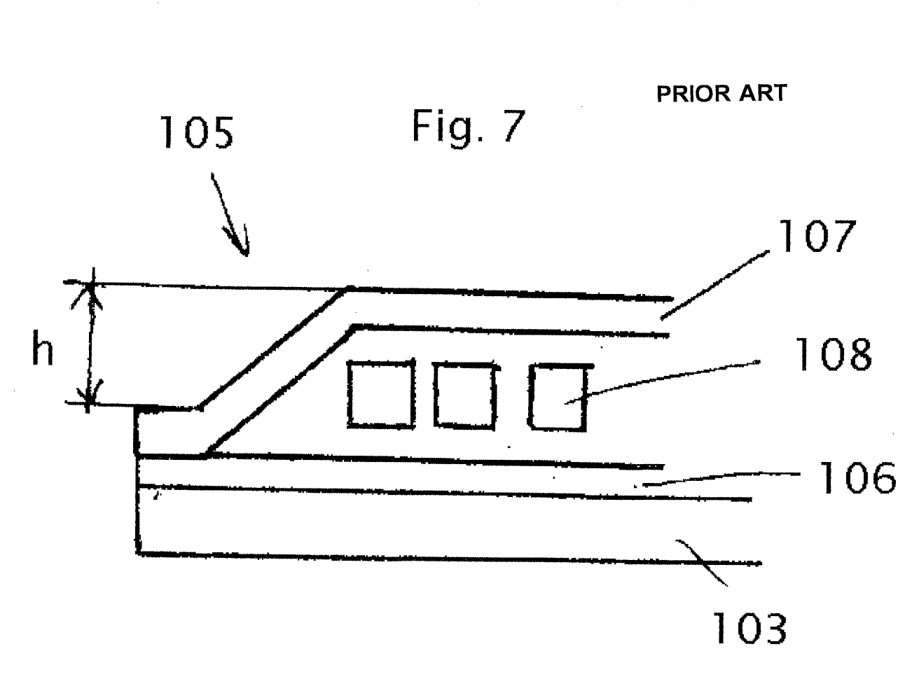

Referring to FIG. 5, a plurality of parallel first patterns 17 are formed with a preferred spacing from each other on a surface of coil 16. Then, U-shaped yoke is formed. Subsequently, a plurality of parallel second patterns 18 are formed for mounting on U-shaped yoke 15. The plurality of second patterns 18 respectively are formed to connect to the plurality of first patterns 17, thereby forming coil 16.

The opposed ends of coil 16 are connected to an electric power source, by which a preferred current is supplied to coil 16 to generate a preferred magnetic field. Due to the magnetic field generated in coil 16 a magnetic flux flows inside U-shaped yoke 15 whereby a signal magnetic field which can be written in the magnetic recording element is generated in the magnetic gap. Although not illustrated, an insulation layer is disposed between plurality of first patterns 17, plurality of second patterns 18 and U-shaped yoke 15.

The advantageous effects of the present invention will be described hereinafter.

By adjusting the width of yokes 5, 6 at one's own option, the track width w of regenerating magnetic core 1 can be controllable easily by means of a photo lithographic process. Accordingly, it is possible to narrow the track width w of regenerating magnetic core 1 greatly, so that a high density recording is attainable.

In the same way, by adjusting the width of U-shaped yoke 15 at one's own option, the track width W of recording magnetic core 2 can be controllable easily by the photo lithographic process. Accordingly, it is possible to narrow the track width W of recording magnetic core 2 greatly, so that a high density recording is attainable.

Since magnetic gap 1g of regenerating magnetic core 1 is directed toward a side face direction, and magnetic gap 2g of recording magnetic core 2 is also directed toward a side face direction, it is easy to form a preferred track width of magnetic cores 1, 2.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A magnetic head having a tunneling magnetoresistance effect comprising:
a substrate;
a first non-magnetic layer on said substrate;
a regenerating magnetic head anchored in said first non-magnetic layer;
said regenerating magnetic head including a regenerating magnetic core;
a regenerating magnetic gap of said regenerating magnetic core being directed toward a side face direction of said first non-magnetic layer;
a tunneling magnetoresistance effect element connected to said magnetic core;
a magnetic flux from said tunneling magnetoreisistance effect element being applied to said tunneling magnetoresistance effect element;
a second non-magnetic layer disposed on said tunneling magnetoresistance effect element;
a shield magnetic layer disposed on said second non-magnetic layer;
a third non-magnetic layer disposed on said shield magnetic layer;
a recording magnetic head disposed on said third non-magnetic layer;
a recording magnetic gap of said recording magnetic head being directed toward a side face direction; and
magnetic field generating means for supplying a magnetic flux to said recording magnetic core and thereby generating a magnetic field in said recording magnetic gap.

2. A magnetic head according to claim 1, wherein a track width of said regenerating magnetic core is controllable by setting a thickness thereof at one's own option.

3. A magnetic head according to claim 1, wherein the track width of said recording magnetic core is controllable by setting a thickness thereof at one's own option.

4. A magnetic head according to claim 1, in which said magnetic field generating means includes:
a coil;
said coil including a plurality of first patterns spaced from each other and a plurality of second patterns spaced from each other; and
said plurality of first patterns are connected in series respectively with said plurality of second patterns.

5. A magnetic head according to claim 1, wherein said tunneling magnetoresistance element includes:
a magnetism free layer for varying a magnetism direction toward a magnetic flux flowing in said regenerating magnetic core;
a magnetism fixing layer for not varying a magnetism direction toward a magnetic flux flowing in said regenerating magnetic core;
an insulating layer disposed between said magnetism free layer and said magnetism fixing layer;
a reinforced magnetism fixing layer;
an upper electrode and a lower electrode effective to supply a tunneling current, between which said magnetism free layer and said insulating layer; and
said insulating layer, said magnetism fixing layer and said reinforced magnetism fixing layer are laid one upon another.
